(19) United States
(12) Patent Application Publication
(10) Pub. No.: US 2025/0338933 A1
(43) Pub. Date: Nov. 6, 2025

(54) CELL PHONE CASE

(71) Applicant: Brandon Jon Michael, Catonsville, MD (US)

(72) Inventor: Brandon Jon Michael, Catonsville, MD (US)

(21) Appl. No.: 18/655,395

(22) Filed: May 6, 2024

(51) Int. Cl. A45C 11/00; H04B 1/3888

(52) U.S. Cl. CPC A45C 11/00; H04B 1/3888; A45C 11/002

(57) ABSTRACT

A cell phone case with a storage compartment that has multiple sections and a slidable lid. The storage compartment is on the rear side of the case. The slidable lid is contained by a lip that ensures the lid slides only in one direction laterally and stays attached to the cell phone case storage compartment.

### FIELD

The present disclosure relates generally to the field cell phone cases, and, more specifically, to cell phone cases that have storage mechanisms. The field of disclosure encompasses aspects of cell phone case storage pockets.

### BACKGROUND

Over the last several years, the number of smart phone subscriptions has exceeded over six billion. The growing capabilities of these devices have made them a quintessential accessory in today's world. Consumers have become accustomed to the convenience of using their phone not only for communicating with others, but also for photography, research, and even managing health data. It follows that phone cases should also serve multiple functions. While there are cell phone cases with compartments to carry small personal items, such as cards or cash, there are limited cases that provide the ability to wider items such as a smoking apparatus. In the US, there are approximately twenty-eight million adult smokers. In particular, users of tobacco usually need a separate carrying case for the product as well as accompanying rolling papers. These drawbacks impede the potential convenience that could be provided to smokers.

### SUMMARY

In light of the foregoing background, the following presents a simplified summary of the present disclosure to provide a basic understanding of some aspects of the disclosure. This summary is not an extensive overview of the disclosure. It is not intended to identify key or critical elements of the disclosure, or to delineate the scope of the disclosure.

The following summary merely presents some concepts of the disclosure in a simplified form as a prelude to the more detailed description provided below. The present technology provides an article of manufacture which can act as a carrying holder for plant-based combustibles while doubling as a cellphone cover.

According to an aspect of the present technology, a mobile device case comprises: a mobile device section configured to securely hold a mobile communication device therein; and a compartment attached along the rear side of the mobile device section, the compartment includes: two vertically separated sections configured to securely hold loose plant-based combustibles and a rolled smoking apparatus; and a sliding apparatus along the top side of the compartment to secure the products therein.

According to an aspect of the present technology, an electronic device case includes side portions and a rear back portion. The rear back portion of the cover includes a multiple compartment storage portion with a slidable lid feature thereon.

According to an aspect of the present technology, the electronic device case may include the storage compartment on the rear side of the case, features internally molded compartments adapted to retain plant-based combustibles and other small materials.

According to an aspect of the present technology, the electronic device case the storage compartment features a slidable lid that slides laterally across to fully cover the opening of the internally molded compartments.

According to an aspect of the present technology, the electronic device case the storage compartment features an angled surface at a 40-degree angle with a lip that ensures the slidable lid slides laterally and stays attached to the electronic device case storage compartment.

According to an aspect of the present technology, a phone case includes a multi-unit compartment with a sliding lid that can be used to conveniently store plant-based combustibles. A phone case includes a plurality of side portions, a rear back portion and a mobile device section configured to securely hold a mobile communications device therein. The mobile communications device has a display screen being exposed for use while the mobile communications device is being retained in said mobile device section. The rear back portion includes a multiple compartment storage portion with a slidable lid feature thereon configured to open and close said compartment storage portion.

### BRIEF DESCRIPTION OF THE DRAWINGS

FIG. 1 is a front view according to certain aspects of the present disclosure.

FIG. 2 is a back view of the phone case depicting the container and cover according to certain aspects of the present disclosure.

FIG. 3 is a perspective view from the top of the phone case depicting the sliding direction of the container cover according to certain aspects of the present disclosure.

FIG. 4 is a cross sectional view top view of the phone case depicting the larger and smaller containers according to certain aspects of the present disclosure.

FIG. 5 is cross sectional bottom view of the phone case depicting the openings to the larger and smaller containers according to certain aspects of the present disclosure.

FIG. 6 is an angled left back view of the phone case depicting the container cover when closed covering the openings to the larger and smaller containers according to certain aspects of the present disclosure.

FIG. 7 is a cross sectional view of the left side of the phone case depicting the larger container according to certain aspects of the present disclosure.

FIG. 8 is a cross sectional view of the right side of the phone case depicting the smaller container according to certain aspects of the present disclosure.

FIG. 9 is a cross sectional view of the left side of the phone case depicting the container cover that slides inside the track with an angled lip.

FIG. 10 is an illustrative block diagram of a mobile digital computing environment that may be used to implement the processes and functions of certain embodiments.

### DETAILED DESCRIPTION

The features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings.

Terms of degree such as “generally”, “substantially”, “about” and “approximately” as used herein mean a reasonable amount of deviation of the modified term such that the end result is not significantly changed. For example, these terms can be construed as including a deviation of at least +−0.5% of the modified term if this deviation would not negate the meaning of the word it modifies.

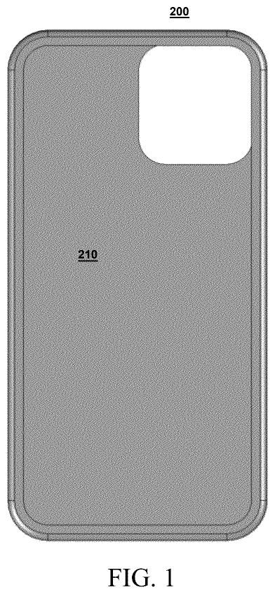

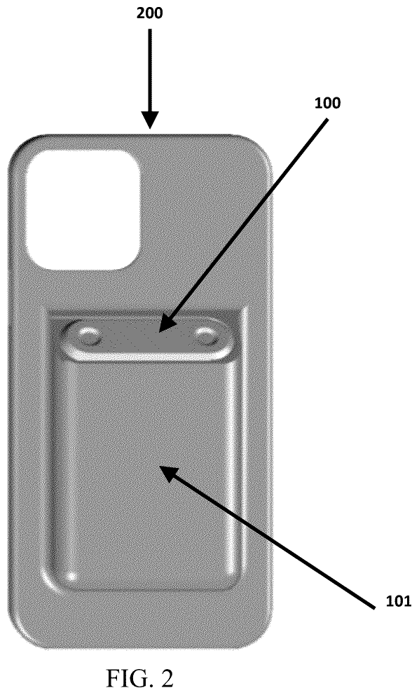

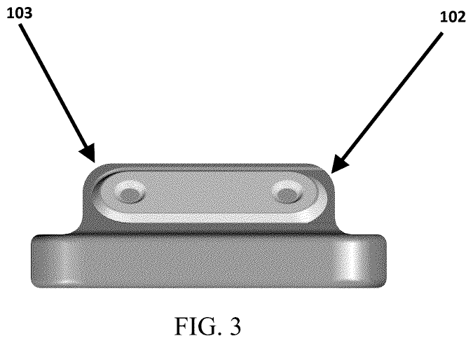

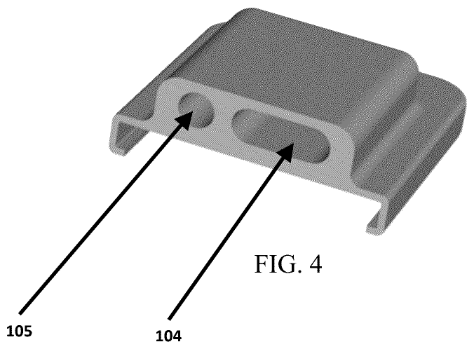

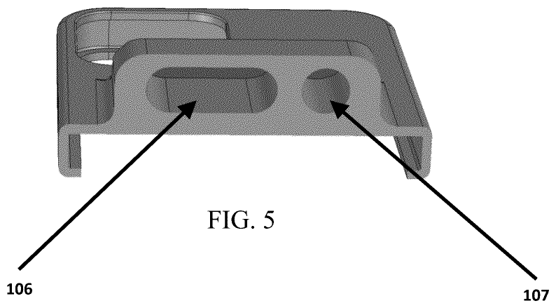

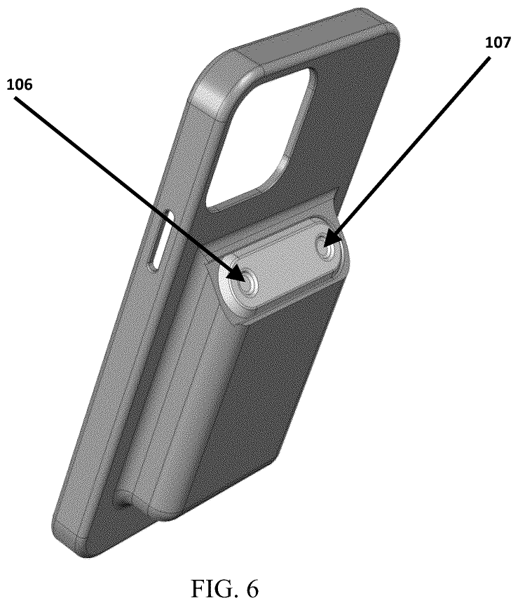

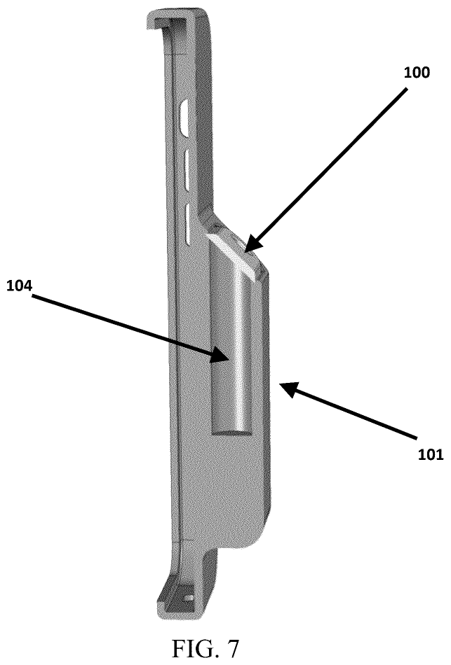

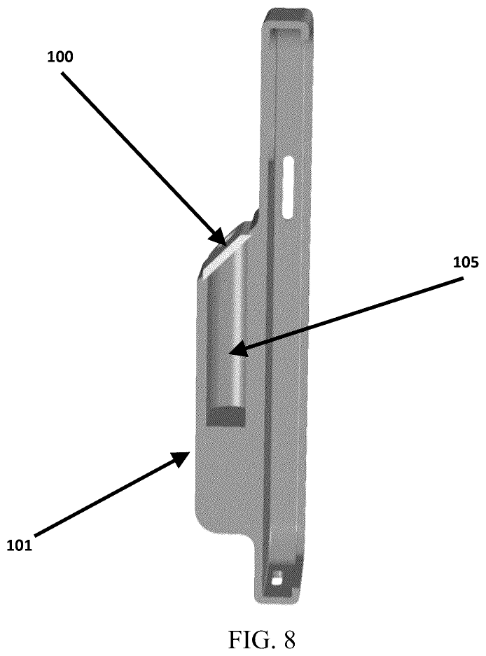

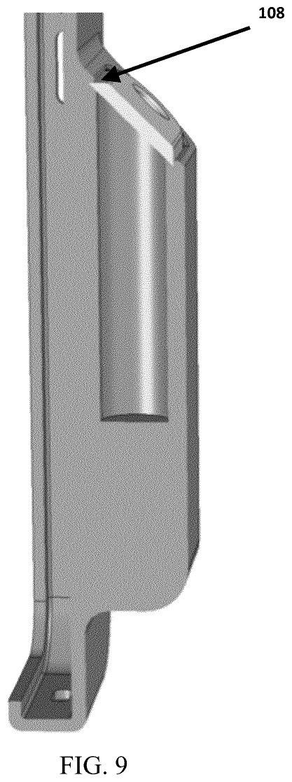

The present specification with FIGS. 1-10, as well as various commercial and consumer products, provides a phone case 200 designed to provide a closable container pocket 101 with a larger container 106 based on volumetric capacity and a smaller container 107 based on volumetric capacity. That is, container 106 has a larger volumetric capacity than container 107.

The container cover 100 slides closed in one direction towards a right-handed thumb 102 and is closed towards a left-handed thumb 103. The container cover slides inside of a 40-degree angled track 108 that holds the sliding cover 10 while it slides back and forth. When closed, the container cover 100 seals the openings to the larger container 106 opening and the smaller container 107 opening.

This innovative approach ensures that the materials stored inside the containers 106, 107 are prevented from falling out when the phone case is carried in different orientations and sealing provides for water resistance. The phone case 200 with mobile device section 210 can be provided in a number of different constructions of plastic materials. The mobile device section 210 includes a cavity portion configured to retain a mobile communications device 700 within the phone case 200.

In one example, the plastic material may be a polypropylene plastic. The polypropylene plastic is made by combining propylene monomers. The phone case 200 may be of a molded construction, including injection molded or casted.

The container cover 100 may be made from either a rubberized material or silicone. Rubberized materials are typically made from natural rubber or synthetic rubber compounds, while silicone is a synthetic polymer made primarily of silicone, oxygen, carbon, and hydrogen.

The size of the larger container 104 and smaller container 105 may be portionally related to the overall size of the phone case 200 that is manufactured to support a broad array of phone types. The combined width of the containers is 80% of the width of the phone. The combined length of the containers is 60% of the length of the phone. The height of the containers is 110% the height of the phone. The mobile communications device 700 can be cellular phones, such as APPLE IPHONE 13, APPLE IPHONE 14, APPLE IPHONE 15, for example.

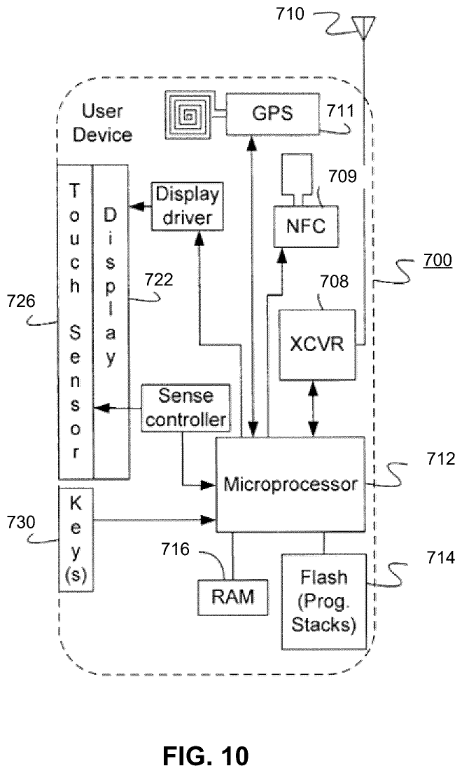

FIG. 10 provides a block diagram illustration of an exemplary mobile communications device 700. Although the mobile communications device 700 may be a smart-phone, a tablet, or another type of device, the illustration shows the user 700 is in the form of a handset (although many components of the handset, such as a microphone, speaker and camera, are not shown for clarity).

Referring to FIG. 10 for digital wireless communications, the mobile communications device 700 includes at least one digital transceiver (XCVR) 708 connected to an antenna 710 that receives data packets uploads and downloads using cell tower transmissions with an information alert (e.g., push notification) from an Over-The-Air Transmitter 802. The transceiver 708 provides two-way wireless communication of information, such as digital information. The transceiver 708 also sends and receives a variety of signaling messages in support of the various services provided via the user device 700 and the communication network. The user device 700 also includes an NFC interface 709 having an associated antenna and configured for communicating using near-field communication with other devices such as with an NFC reader. The mobile communications device 700 includes a display 722 for displaying messages, menus or the like, user related information for the user, etc. A touch sensor 726 and keypad 730 enables the user to generate selection inputs, for example.

A microprocessor 712 serves as a programmable controller for the mobile communications device 700, in that it controls all operations of the user device 700 in accord with programming that it executes, for all normal operations, and for operations involved in the real-time parking guidance service. In the example, the mobile communications device 700 includes flash type program memory 714, for storage of various program routines and configuration settings. The user device 700 may also include a non-volatile random access memory (RAM) 716 for a working data processing memory. In a present implementation, the flash type program memory 714 stores any of a wide variety of applications, such as navigation application software. The memories 714, 716 also store various data, such as input by the user. Programming stored in the flash type program memory 714 is loaded into and executed by the microprocessor 712 to configure the processor 712 to perform various desired functions, including functions involved in push notification processing.

In some examples, the user device 700 further includes a GPS interface 711 coupled to a GPS antenna designed to receive GPS location signals transmitted by satellites. The GPS interface 711 is communicatively coupled to the microprocessor 712, and is operative to provide location information to the microprocessor based on the received location signals.

In one construction, a biometric device system located in Device 700 may be included to enable for securely storing in the device biometric data unique to the user, and/or securely storing in the device behavioral/gating data associated with the user. The electronic biometric data and behavioral/gating data can be maintained, or otherwise stored within a memory/database, such as memory 714.

Furthermore, the mobile communications device 700 has a display screen 722 being exposed for use, while the mobile communications device 700 is being retained in the mobile device section 210, such that the rear back portion includes a multiple compartment storage 106, 107 with a slidable lid 100 feature thereon.

Although the components and methods of the present specification as well as various commercial and consumer products containing/comprising the same have been described with respect to specific embodiments and examples, it should be appreciated that the present teachings are not limited thereto and other embodiments utilizing the concepts expressed herein are intended and contemplated without departing from the scope of the present teaching as intended in the true spirit and scope of the invention. It is therefore intended any and all modifications, variations, or equivalents that fall within the spirit and scope of the underlying principles are within the scope of this present disclosure and are covered by the appended claims.

It should be noted that the terms “including” and “comprising” should be interpreted as meaning “including, but not limited to”.

In this specification, “a” and “an” and similar phrases are to be interpreted as “at least one” and “one or more.” References to “the,” “said,” and similar phrases should be interpreted as “the at least one”, “said at least one”, etc. References to “an” embodiment in this disclosure are not necessarily to the same embodiment.

It is the applicant's intent that only claims that include the express language “means for” or “step for” be interpreted under 35 U.S.C. 112. Claims that do not expressly include the phrase “means for” or “step for” are not to be interpreted under 35 U.S.C. 112.

What is claimed is:

1. An electronic device case for a mobile communications device, comprising:
a plurality of side portions, a rear back portion and a mobile device section configured to securely hold a mobile communications device therein; the mobile communications device having a display screen being exposed for use while said mobile communications device is being retained in said mobile device section; and
said rear back portion includes a multiple compartment storage portion with a plurality of openings; and
a slidable lid thereon configured to open and close said compartment storage portion.

2. The electronic device case of claim 1, wherein the compartment storage portion on the rear back portion of the case, further comprises internally molded compartments being adapted to hold plant-based combustibles and other small materials therein.

3. The electronic device case of claim 1, wherein the compartment storage portion further comprises the slidable lid which slides laterally across to fully cover the openings of said internally molded compartments.

4. The electronic device case of claim 1, wherein the compartment storage portion further comprises an angled surface at a 40-degree angle with a lip that enables the slidable lid to slide laterally and stay attached to the compartment storage portion.

5. The electronic device case of claim 4, wherein the angled surface and the lip comprises a track.

6. The electronic device case of claim 4, being molded with a synthetic polymer.

7. The electronic device case of claim 4, being molded with a polypropylene plastic.

8. The electronic device case of claim 4, being molded with a rubberized material.
